(19) United States
(12) Patent Application Publication
(10) Pub. No.: US 2015/0104775 A1
(43) Pub. Date: Apr. 16, 2015

(54) CELESTIAL GLOBE

(71) Applicants: Chang-Jen WU, Taoyuan County (TW); Shih-Yi LIN, Taoyuan County (TW)

(72) Inventors: Chang-Jen WU, Taoyuan County (TW); Shih-Yi LIN, Taoyuan County (TW)

(21) Appl. No.: 14/511,576

(22) Filed: Oct. 10, 2014

(30) Foreign Application Priority Data
Oct. 15, 2013 (TW) 102219191

(51) Int. Cl. G09B 27/06

(52) U.S. Cl. CPC G09B 27/06
USPC 434/287

(57) ABSTRACT

A celestial globe model includes several petal-shaped sheets and two circular sheets fabricated from transparent and flexible material. Each petal-shaped sheet has two opposite end portions respectively defining a notch and two long curved edges interconnected with corresponding long curved edges of an adjacent petal-shaped sheet to form a sphere like body with a circular opening confined by the notches. The inner surface of the sphere like body is formed with the first celestial coordinate pattern. The circular sheets are connected sealing to the peripheries of the notches of the petal-shaped sheets to form the sphere like body once inflated. Each circular sheet has an inner surface formed with the second celestial coordinate pattern. An inflate valve is mounted on one of the circular sheets for inflating and deflating the sphere-like body.

### CROSS-REFERENCE TO RELATED APPLICATION

This application claims the priority of Taiwanese patent application No. 102219191, filed on Oct. 15, 2013, which is incorporated herewith by reference.

### BACKGROUND OF THE INVENTION

1. Field of the Invention

The present invention relates to a globe, more particularly to a celestial globe that is cheap in manufacturing cost and convenient for every one to observe astronomical objects from the earth so as to achieve the motive of teaching and learning astronomy.

2. The Prior Arts

A celestial globe is an instrument that is generally used for observing astronomical objects from the earth, such as stars, planets in solar system, star clusters, and galaxies. A traditional celestial globe model is generally made from hard plastic material with high transparency so that celestial coordinates of astronomical objects can be directly printed on the hard covering thereof. The cost of the traditional celestial globe model is usually expensive because of that the hard plastic model can not be manufactured with the common printing techniques. The majority of schools can only buy one or two traditional celestial globe models for teaching astronomy, but it is not enough for every student to have one in the class while they are studying, and they cannot bring home the globe models for further learning.

In addition, the hard plastic covering of the celestial globe model may be damaged or scratched in case of impacts or collisions and the scratches remain thereon may lead to misreading the celestial coordinates of the astronomical objects.

Moreover, the hard covering of the celestial globe model cannot be compressed into compact size is another reason so that the students cannot take it outdoors for observing the astronomical objects at night.

A real celestial globe model should be manufactured according to the real and common experiences of people's life. When people observe the astronomical objects, they observe the constellation from the earth to see the sky, it is a right direction for observing the constellation, but not from the outside of the earth, which is a wrong direction for observing the constellation. Therefore, the real celestial coordinate patterns should be shown on the inner surface of the globe. The traditional beach-ball-type celestial globe models are designed to observe the astronomical objects from outside of the earth, therefore the celestial coordinate patterns are shown on the outer surface of the globe. As a result, the traditional globe models show the wrong mirror images of the constellations and astronomical objects that lead to a wrong celestial concept and teaching.

### SUMMARY OF THE INVENTION

Therefore, the object of the present invention is to provide a celestial globe that is cheap in manufacturing cost and more convenient for every one to observe astronomical objects from the earth so as to achieve the motive of teaching and learning astronomy.

The celestial globe according to the present invention is fabricated from transparent and flexible material and is a sphere like body once inflated, which has inner surface formed a celestial coordinate pattern different from each other. Each celestial coordinate pattern is depicted by observing celestial objects from the earth to see the sky, whereas a mirror image of the celestial coordinate patterns is formed on outer surfaces of sphere like body. In use, an observer can look into the inner side of the sphere like body showing the accurate located celestial coordinate pattern from its outer side of the sphere like body so as to learn or study the precise location of a respective celestial coordinate pattern and a specific astronomical object. Upon requirement, the sphere like body can be deflated to minimize its dimension so that a learner easily carries outdoors for study astronomy.

The celestial globe of the present invention includes a plurality of petal-shaped sheets fabricated from transparent and flexible material through Rectangular Polyconic map projection, two circular sheets and an inflatable valve. Each of the petal-shaped sheets has an inner surface and an outer surface opposite to the inner surface. Each of the petal-shaped sheets further has two opposite end portions respectively defining a notch and two opposite long curved edges extending between the opposite end portions and interconnected with corresponding long curved edges of an adjacent petal-shaped sheet, thereby forming a sphere like body with a circular opening confined by the peripheries of the notches. The inner surface of each of the petal-shaped sheets is formed with the first celestial coordinate pattern different from one another. The circular sheets are fabricated from transparent and flexible material and are connected sealing to the peripheries of the notches of the plurality of petal-shaped sheets in order to form the sphere like body once inflated. Each of the circular sheets has an inner surface and an outer surface opposite to the inner surface, wherein the inner surface of each of the circular sheets is formed with the second-celestial coordinate pattern different from each other. An inflatable valve is mounted on one of the circular sheets for inflating the sphere.

One aspect to note is that each of the petal-shaped sheets are fabricated through the Rectangular Polyconic map projection, the respective celestial coordinate is formed on the respective inner surface of the petal-shaped sheet through the numerical simulation application so that each of celestial coordinate patterns corresponds with the precise position of the real celestial coordinate, thereby minimizing the standard error of the real celestial coordinates.

Owing to the features of each petal-shaped sheet and each circular sheet are manufactured respectively and then stuck together, which lowers manufacturing cost, whoever wishing to study or observe the astronomical objects in the sky can afford to buy the celestial globe of the present invention. Since the sphere like body of the celestial globe can be deflated, it is convenient for the observer carries the celestial globe outdoors for further study of astronomy.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a schematic view of a petal-shaped sheet employed in a celestial globe of the present invention, a plurality of which cooperatively form the celestial globe of the present invention;

FIG. 2 shows the petal-shaped sheet of FIG. 1, which has a plurality of celestial coordinate patterns formed through numerical simulation application in the present invention;

FIG. 3 is a spread-out view of the plurality of petal-shaped sheets in FIG. 1, upon which several celestial coordinate patterns are fabricated through the numerical simulation application;

FIG. 4 shows a schematic view of a circular sheet employed in the celestial globe of the present invention;

FIG. 5 is a perspective view of the celestial globe of the present invention in inflated state, which is formed by two circular sheets of FIG. 4 and the plurality of petal-shaped sheets of FIG. 1; and

FIG. 6 is a planar cross-section view of the celestial globe of the present invention in inflated state.

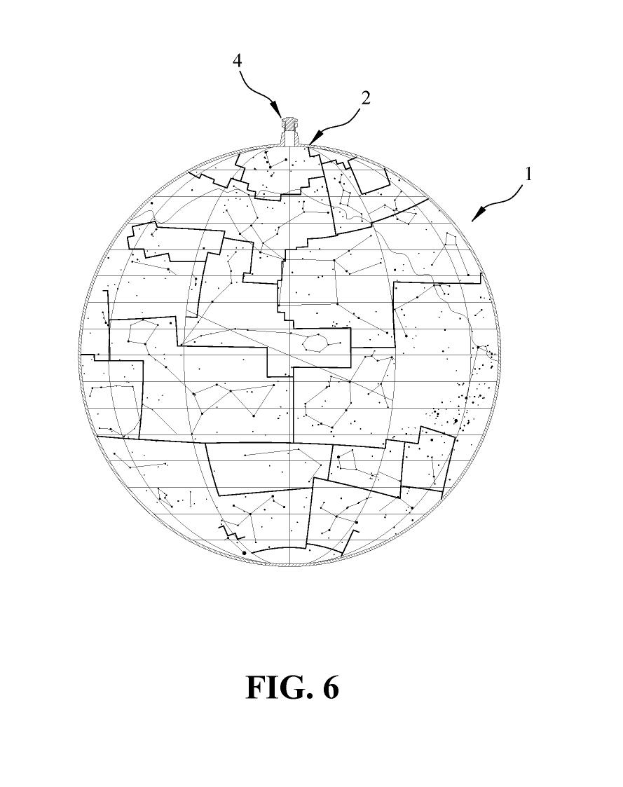

### DETAILED DESCRIPTION OF THE PREFERRED EMBODIMENTS

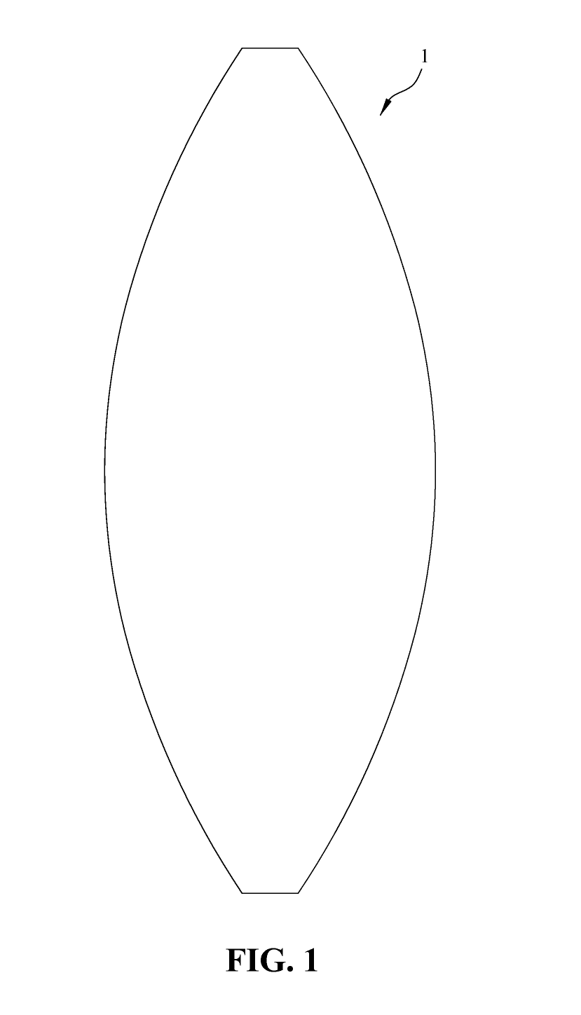

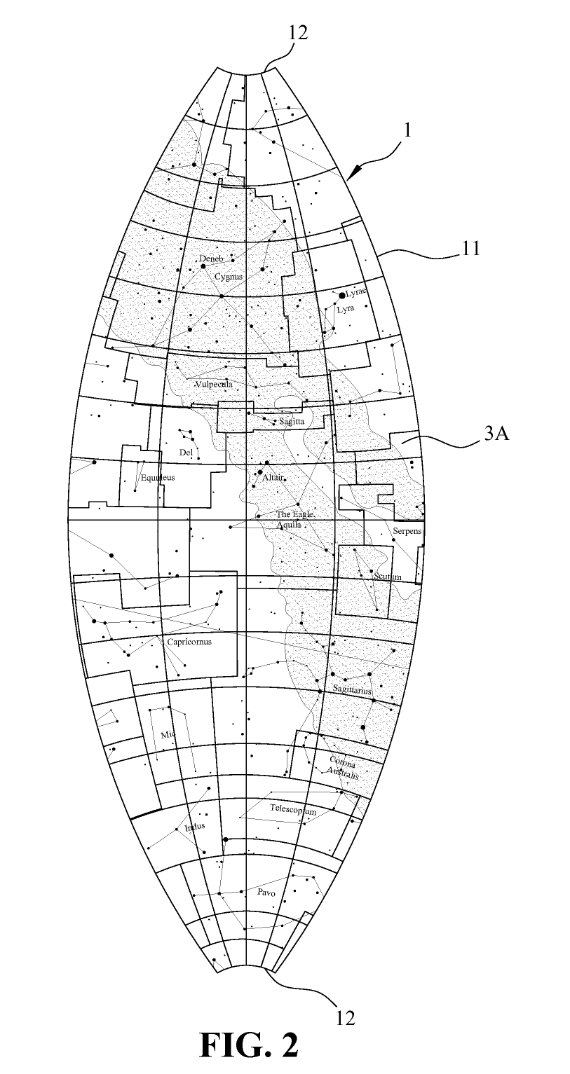

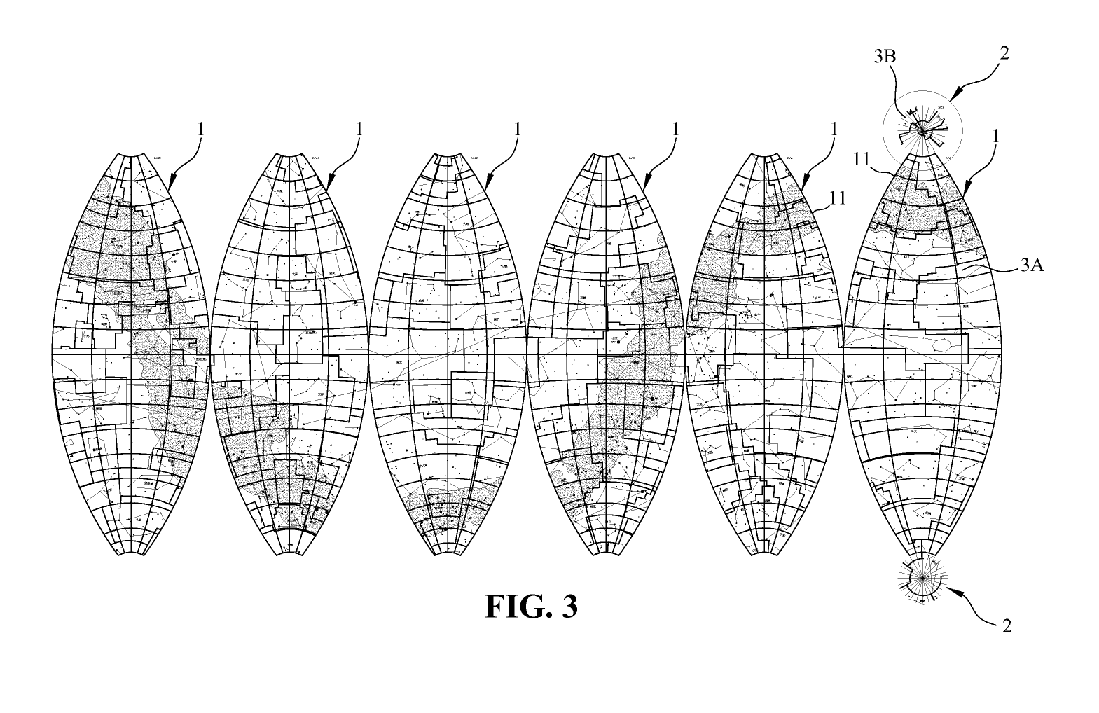

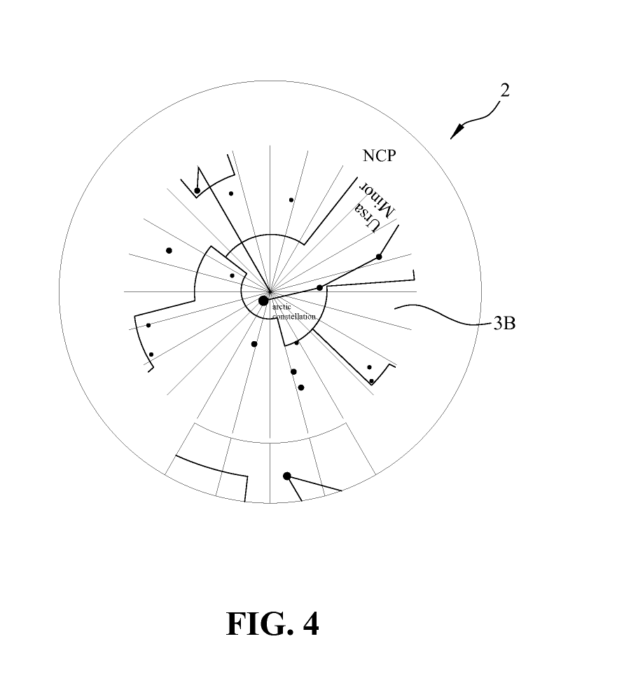

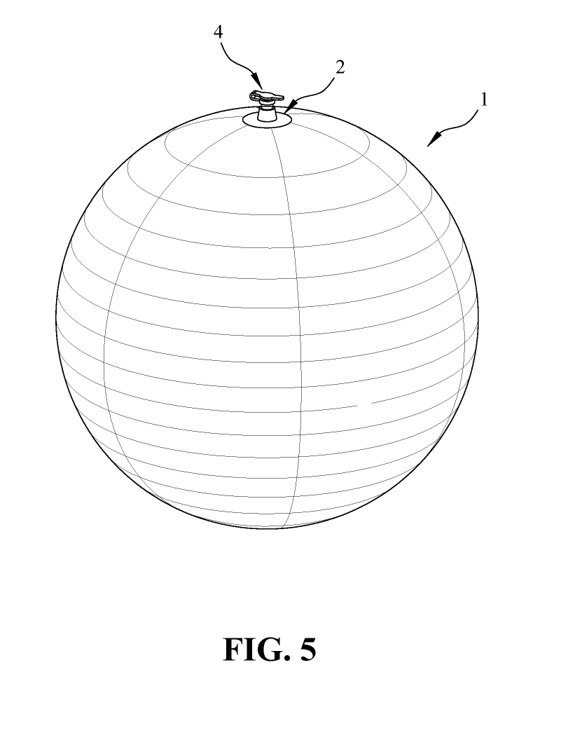

Referring to FIGS. 1 to 4, a celestial globe of the present invention is an inflatable sphere like body which is fabricated from flexible material (like transparent or light pervious plastic) such that it can be inflated to be the sphere like body upon requirement or deflated to minimize the storage space thereof. The celestial globe of the present invention includes a plurality of petal-shaped sheets 1 (see FIG. 1), two circular sheets 2 (see FIG. 4) and an inflatable valve 4 (see FIG. 5). The plurality of petal-shaped sheets 1 are fabricated from transparent and flexible material through Rectangular Polyconic map projection and later are cut into several single pieces of different dimension upon requirement for forming celestial globe of different sizes. Each of the petal-shaped sheets 1 has an inner surface and an outer surface opposite to the inner surface, wherein the inner surface of each of the petal-shaped sheets 1 is formed with the first celestial coordinate pattern 3A different from one another. Each of the petal-shaped sheets 1 further has two opposite end portions 12 respectively defining a notch (generally curved notch) and two opposite long curved edges 11 that extend between the opposite end portions 12 and that are interconnected with corresponding long curved edges of two adjacent petal-shaped sheets 1 through ultrasonic plastic welding process, thereby forming a sphere like body with a circular opening confined by the peripheries of the notches in the end portions 12. Under this condition, the first celestial coordinate pattern 3A is located on an inner surface of the sphere like body. It is to note that the first celestial coordinate pattern 3A includes a group of celestial objects (a group of the first celestial coordinate patterns), each of which represents a real celestial object (like planets in solar system, star clusters, and galaxies) that people can observe from the earth to see the sky.

The circular sheets 2 are fabricated from transparent and flexible material (like transparent or light pervious plastic) and are connected sealingly to the peripheries of the notches in the plurality of petal-shaped sheets 1 through ultrasonic plastic welding process in order to form the sphere like body once inflated. Each of the circular sheets 2 has an inner surface and an outer surface opposite to the inner surface, wherein the inner surface of each of the circular sheets 2 is formed with the second celestial coordinate pattern 3B different from each other and the first celestial coordinate pattern. It is to note that second celestial coordinate pattern 3B includes a group of celestial objects (a group of the second celestial coordinate patterns), each of which represents a real celestial object that can be observed from the earth to see the sky.

In the present invention, the inflatable valve 4 is mounted on one of the circular sheets 2 for inflating and deflating the sphere-like body upon requirement. Alternately, the inflatable valve 4 can be mounted on one of petal-shaped sheets 1 so long as it can inflate or deflate the sphere like body. As illustrated in FIG. 5, the inflatable valve 4 is formed on the upper circular sheet 2 to facilitate injection of air into sphere-like body or deflating the air out from the sphere-like body.

The celestial globe of the present invention includes a plurality of petal-shaped sheets 1, two circular sheets 2 and an inflatable valve 4. Because each of petal-shaped sheets is fabricated from transparent and flexible material through Rectangular Polyconic map projection, the inner surface of each circular sheet is formed with a different celestial coordinate pattern, it is difficult just to stick each of petal-shaped sheets to have a sealed tightly globe. Prior to print the first celestial coordinate pattern 3A onto each of petal-shaped sheets 1, which need to project the accurate first celestial coordinate pattern 3A so as to meet with each location of petal-shaped sheets 1 through the computer by calculating numerical analysis, so that each of the celestial coordinate patterns corresponds with the precise position of the real celestial coordinates. When in the inflated state, the first and second celestial coordinate patterns 3A, 3B are located on the inner surface of the sphere-like body and are visible from an exterior of the sphere-like body, which is similar to people standing on the earth and looking up into the sky to observe the celestial objects.

Another aspect to note in the present invention is that since the inflate valve 4 has the traditional structure and is mounted on one of the circular sheets 2; a detailed description thereof is omitted herein for the sake of brevity.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An inflatable celestial globe comprising:
a plurality of petal-shaped sheets fabricated from transparent and flexible material through Rectangular Polyconic map projection, each of said petal-shaped sheets having an inner surface and an outer surface opposite to said inner surface, each of said petal-shaped sheets further having two opposite end portions respectively defining a notch and two opposite long curved edges extending between said opposite end portions and interconnected with corresponding long curved edges of an adjacent petal-shaped sheet, thereby forming a sphere like body with a circular opening confined by the peripheries of said notches, wherein said inner surface of each of said petal-shaped sheets is formed with the first celestial coordinate pattern different from one another; and
two circular sheets fabricated from transparent and flexible material and connected sealingly to the peripheries of said notches of said plurality of petal-shaped sheets in order to form the sphere like body once inflated, each of said circular sheets having an inner surface and an outer surface opposite to said inner surface, wherein said inner surface of each of said circular sheets is formed with the second celestial coordinate pattern.

2. The inflatable celestial globe according to claim 1, further comprising an inflatable valve mounted on one of said circular sheets for inflating the sphere like body.

3. The inflatable celestial globe according to claim 1, wherein said celestial coordinate patterns forming on said inner surfaces of sphere that depicted by observing celestial objects from the earth to see the sky, whereas a mirror image of said celestial coordinate patterns is formed on said outer surfaces of sphere.
